(19) United States
(12) Patent Application Publication
(10) Pub. No.: US 2012/0297597 A1
(43) Pub. Date: Nov. 29, 2012

(54) Flow Max Coupler

(76) Inventor: Brandon R. Heller, Stockton, IL (US)

(21) Appl. No.: 13/478,859

(22) Filed: May 23, 2012

Related U.S. Application Data
(60) Provisional application No. 61/489,064, filed on May 23, 2011.

(51) Int. Cl. B25B 27/10; B23P 19/04

(52) U.S. Cl. 29/237; 29/257

(57) ABSTRACT

An architecture is presented that provides a tool for uncoupling a breakaway coupling used in a flow line system used with liquid anhydrous ammonia. The compression tool comprises a first member and a second member for engaging the breakaway coupling. The first and second members are secured together with a fixed element and an adjustable element. The adjustable element is typically a threaded rod that allows a user to adjust the bottoms of the first and second members so that they adjust inward creating a sufficient force to overcome a spring holding the breakaway coupler together.

### CROSS-REFERENCE

This application claims priority from Provisional Patent Application Ser. No. 61/489,064 filed May 23, 2011.

### FIELD OF THE INVENTION

This invention pertains generally to a compression tool, and more particularly to a tool for compressing a spring allowing a breakaway coupling device to be uncoupled.

### BACKGROUND

Dangerous liquid chemicals such as anhydrous ammonia are often stored in storage or nurse tanks. When filling or removing the chemical from the tank, a flow line system is typically used that includes a breakaway type connection designed to separate in the event of an emergency. When separated, the breakaway coupling interrupts the flow of the liquid and prevents a toxic chemical release into the environment. These breakaway couplings require periodic maintenance.

One such breakaway coupling is the Flo-Max® Coupler manufactured by PGI International. This particular coupling uses a spring to regulate the force required to separate the coupling. To separate the coupling, the manufacturer teaches using a screwdriver to compress the spring to separate the valve. As the amount of force required to separate the coupling is significant, this process can require two or three people, which is not always practical or possible. Screwdrivers can easily break under the force required to compress the spring which adds to the cost of maintenance. Additionally, it may be dangerous for these individuals to be close to the breakaway while pushing and pulling on it due to the toxic nature of the chemical.

Consequently, there exists a need for a more efficient and safer tool designed to uncouple a breakaway coupling such as a Flo-Max® Coupler used in anhydrous ammonia flow-line systems. The present invention discloses a tool for simplifying the maintenance on the Flo-Max® Coupler that safely compresses the spring to assist in taking the coupling apart. This tool is useful for farmers, chemical transportation companies, or anyone using anhydrous ammonia equipment. The tool allows individuals to safely access the breakaway coupling without breaking or damaging screwdrivers or clamps while trying to pry the coupling open.

### SUMMARY

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a compression tool for safely and easily compressing a spring on a breakaway coupling such as a Flo-Max® Coupler used in a flow-line system for moving liquid anhydrous ammonia so that a single individual may break the coupler apart. The compression tool comprises a first member and a second member for positioning over the Flo-Max® Coupler. A fixed element secures the first member to the second member, and an adjustable element allows the first member to move relative to the second member.

Furthermore, in the preferred embodiment of the invention, the first and second members are essentially steel plates with U-shaped cut-outs designed to fit over portions of the Flo-Max® Coupler. To uncouple the Flo-Max® Coupler, an adjustable element comprising a threaded rod is manipulated so that the bottoms of the first and second members are adjusted inward toward each other approximately ¼ inches, thereby compressing a spring in the Flo-Max® Coupler allowing it to separate.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a prior art perspective view of a Flo-Max® breakaway coupler in an uncoupled position.

FIG. 2 illustrates a prior art perspective view of the Flo-Max® breakaway coupler in an coupled position.

FIG. 3 illustrates a perspective view of a compression tool in accordance with the disclosed architecture.

FIG. 4 illustrates a perspective view of the compression tool in accordance with the disclosed architecture.

FIG. 5 illustrates a cut-away view of the compression tool in use with the Flo-Max® breakaway coupler in accordance with the disclosed architecture.

### DETAILED DESCRIPTION

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

The present invention discloses a tool for safely and easily opening a breakaway coupling. The compression tool comprises a first member and a second member configured essentially as steel plates with U-shaped cut-outs. The first and second members are attached with a fixed steel rod and a movable threaded rod. The threaded rod may be held in place with ordinary fastening elements such as hex nuts and flat washers. To use, an individual may bleed pressure off of the breakaway coupling and place the compression tool over the breakaway coupling. The user then may tighten the fastening element on the movable threaded rod with a wrench, which in turn compresses a spring in the breakaway coupling. As the spring is tightened, the coupling will separate so that the coupling may be serviced, cleaned, replaced and the like.

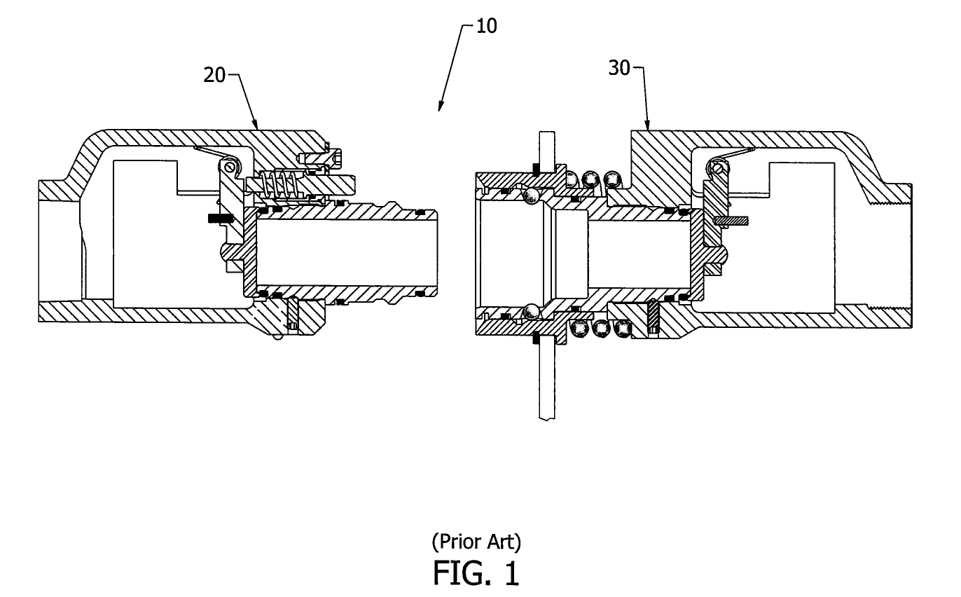

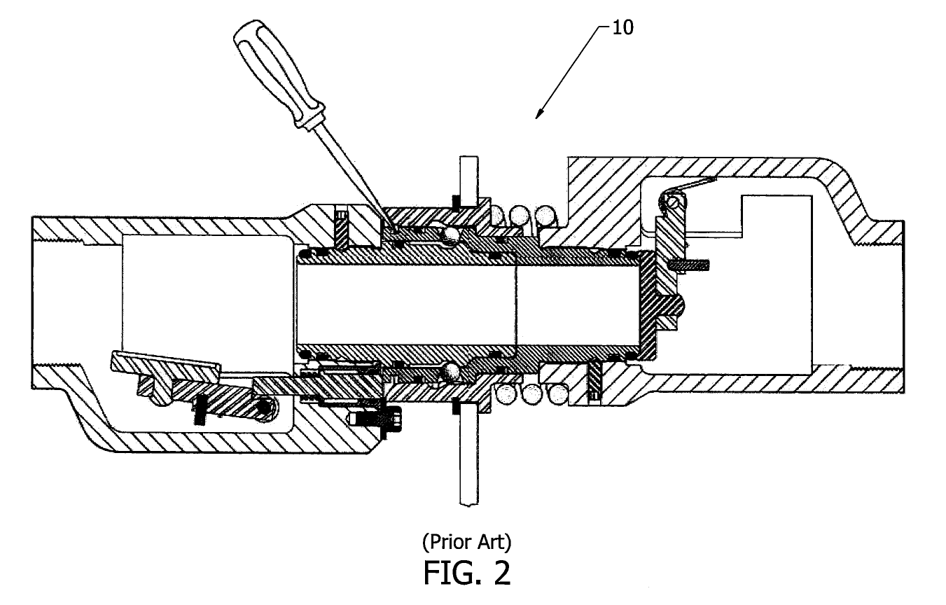

Referring initially to the drawings, FIGS. 1 and 2 illustrate a prior art Flo-Max® Coupler 10 in both an uncoupled (FIG. 1) and a coupled (FIG. 2) position designed to connect an upstream hose (not shown) and a downstream hose (not shown) for permitting the flow of liquid anhydrous ammonia therebetween. The Flo-Max® Coupler 10 comprises a male end 20 and a female end 30. Liquid anhydrous ammonia typically flows from the male end 20 through the female end 30. The Flo-Max® Coupler 10 is an example of a breakaway coupling designed to safely disconnect in the event of an occurrence that would cause either the upstream hose or the downstream hose to become taut enough to potentially rupture.

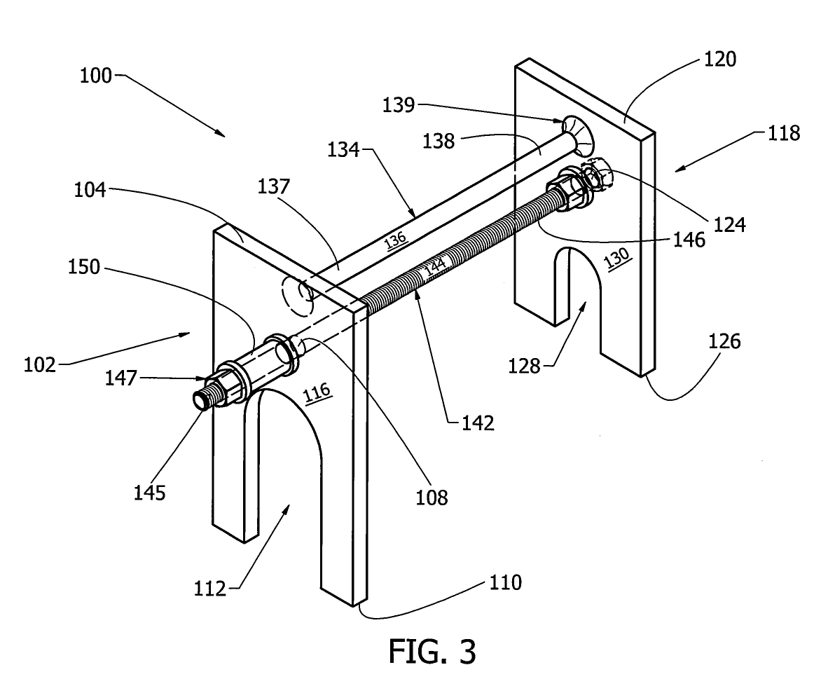

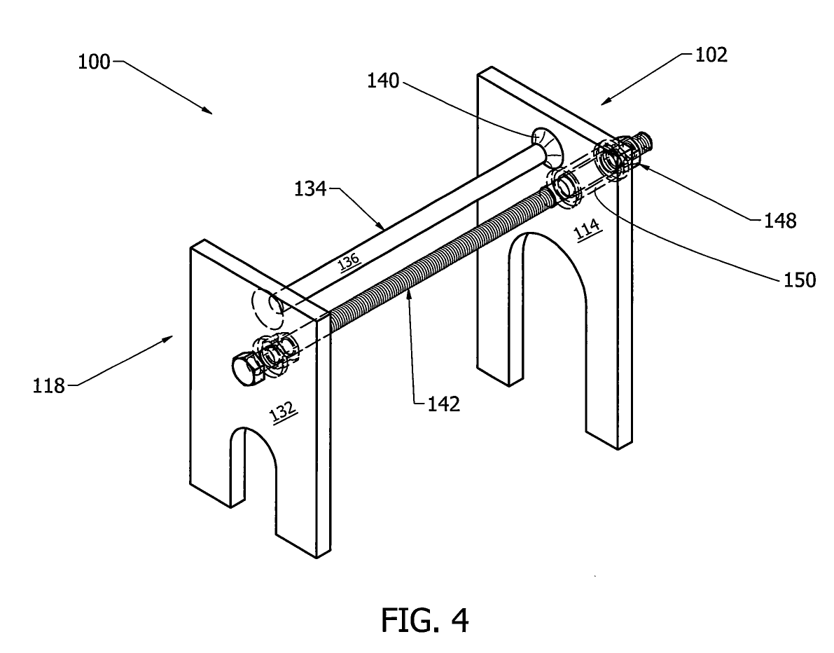

FIGS. 3 and 4 illustrate a compression tool 100 designed for use with a breakaway coupling such as the Flo-Max® Coupler 10. The compression tool 100 is operable by a single user while decreasing the likelihood of tool slippage and/or injury present in the traditional method of uncoupling. The compression tool 100 comprises a first member 102 and a second member 118. The first and second members 102 and 118 are typically approximately a ½ inch thick metal plate constructed of steel, however any other suitable durable material such as cold rolled steel, galvanized steel, steel alloys, high strength composite materials, and the like, as is known in the art may be used without affecting the overall scope of the invention. Similarly, although not required, the first and second members 102 and 118 may be coated with paint, powder coating, a chemical resistant finish, and the like.

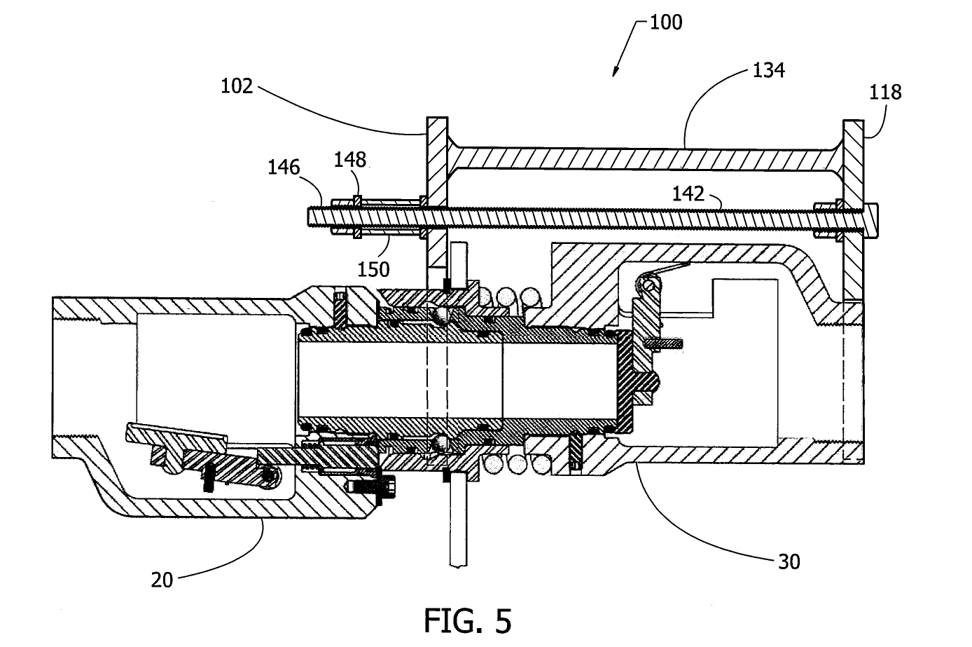

As illustrated in FIGS. 3-5, the first member 102 comprises a first top portion 104 and a first bottom portion 110. The first member 102 further comprises an inner surface 114 and an outer surface 116. The first member 102 is preferably approximately 7½ inches in height and 5 inches in width. However, these dimensions, and all dimensions supra, related to the compression tool may vary between 25 percent larger or smaller, and still be considered within the scope of the invention. The first bottom portion 110 comprises an approximately U-shaped cutout portion 112 measuring approximately 3¾ inches in height and 2¾ inches in width. The approximately U-shaped cutout portion 112 of the first bottom portion 110 is designed to engage and fit over the female end 30 of the Flo-Max® Coupler where the female end 30 connects to the male end 20.

The second member 118 comprises a second top portion 120 and a second bottom portion 126. The second member 118 further comprises an inner facing surface 130 and an outer facing surface 132. The second member 118 is preferably approximately 6¼ inches in height and 4½ inches in width. The second bottom portion 110 comprises an approximately U-shaped cutout portion 128 measuring approximately 1¾ inches in height and 1⅝ inches in width. The approximately U-shaped cutout portion 128 of the second bottom portion 126 is designed to engage and fit over an approximately 1¼ inch diameter outlet from the female end 30 of the Flo-Max® Coupler.

The compression tool 100 further comprises a fixed element 134 and an adjustable element 142. The fixed element 134 is preferably a steel rod 136 approximately ¾ inches in diameter and 6½ inches in length having a first end 137 and a second end 138, although the steel rod 136 may be between 5 and 10 inches in length. The fixed element 134 is substantially centered on the first top portion 104 and the second top portion 120 approximately between ¼ and 1 inches inward respectively. The fixed element 134 secures the first member 102 to the second member 118 so that the first top portion 104 and the second top portion 120 remain substantially a constant distance apart when the compression tool 100 is used. Typically, the second top portion 120 may comprise a through hole (not shown) for the second end 138 of the fixed element 134 to penetrate and be held in place with a positioning element 140 such as a plurality of fasteners, nuts and washers for example. Optionally, the second top portion 120 will not comprise a through hole, and the positioning element 140 can be a flange that directly abuts the inner surface 114 as seen in FIG. 4. The first end 137 may be similarly fastened to the first top portion 104, or may typically be attached to the inner facing surface 114 with a weld 138 or other suitable securing mechanism.

The adjustable element 142 is preferably a threaded steel rod 144 approximately ½ inches in diameter and approximately 10 inches in length having a first end 145 and a second end 146, although the threaded steel rod 144 may be between 9 and 15 inches in length. The adjustable element 142 is substantially centered on the first top portion 104 and the second top portion 120 approximately between 1 and 3½ inches inward respectively. Preferably the fixed element 134 and the adjustable element 142 are approximately 2 inches apart. Additionally, the first end 145 of the adjustable element 142 extends through a first threaded hole 108 in the first member 102 and the second end 146 of the adjustable element 142 extends through a second threaded hole 124 in the second member 118. The second end 146 is typically held in place with a washer/nut combination adjacent to both the inner facing surface 130 and the outer facing surface 132. In other words, the second end 146 is essentially bolted to the second member 118 on both sides.

The adjustable element 142 further comprises an adjusting mechanism 147, typically a nut/washer combination 148, or the like. The adjusting mechanism 147 is located at a terminal position of the first end 145. The adjusting element 142 is typically positioned away from the outer surface 116 of the first element 102 with a sleeve element 150 in between. The sleeve element 150 is preferably an approximately ½ to 1 inch long hollow metal or other suitable material tube that fits over the first end 145 of the adjustable element 142 and abuts the outer surface 116. Then the adjusting mechanism 147 is threaded onto the first end 145.

As the adjustable element 142 is closer to the first and second bottom portions 110 and 126 than the fixed element 134, the adjusting element 142 is used to adjust a distance between the first and second bottom portions 110 and 126, so that the first member 102 can move relative to the second member 118 while the first and second top portions 104 and 120 remain substantially the same distance apart. To decrease the distance between the first and second bottom portions 110 and 126, the adjusting mechanism 147 is turned with a wrench, or the like so that the nut/washer combination 148 adjusts inward, pushing the sleeve element 150 against the outer surface 116, thereby moving the first bottom portion 110 toward the second bottom portion 126. To open the Flo-Max® Coupler 10, approximately between 200 and 300 pounds of force must be generated to over come the spring tension and release the male end 20 from the female end 30. Therefore, the materials of the compression tool 100 are able to resist at least that amount of force. While the distance between the first and second bottom portions 110 and 126 typically only need to decrease by approximately ¼ inch to open the Flo-Max® Coupler 10, the distance between the first and second bottom portions 110 and 126 is adjustable up to 2 inches inward. To release the Flo-Max® Coupler 10 from the compression tool 100, the user simply unscrews the nut/washer combination 148, and the first and second bottom portions 110 and 126 gradually return to a substantially parallel orientation as the pressure is released.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A compression tool for use with a breakaway coupling, the compression tool comprising:
a first member;
a second member;
a fixed element, wherein the fixed element secures the first member to the second member; and
an adjustable element, wherein the adjustable element allows the first member to move relative to the second member.

2. The compression tool of claim 1, wherein the tool is comprised of at least one of the following materials: steel, cold rolled steel, galvanized steel, or a steel alloy.

3. The compression tool of claim 1, wherein the fixed element is a steel rod.

4. The compression tool of claim 1, wherein the adjustable element is a threaded rod.

5. The compression tool of claim 4, wherein the threaded rod is approximately ½ inches in diameter.

6. The compression tool of claim 5, wherein the threaded rod extends through a first threaded hole in the first member and a second threaded hole in the second member.

7. A compression tool for use with a breakaway coupling, the compression tool comprising:
a first member comprising a first top portion and a first bottom portion;
a second member comprising a second top portion and a second bottom portion
a fixed element, wherein the fixed element secures the first member to the second member between the first top portion and the second top portion; and
an adjustable element for adjusting a distance between the first bottom portion and the second bottom portion, wherein the adjustable element allows the first member to move relative to the second member.

8. The compression tool of claim 7, wherein the fixed element is approximately between 5 and 10 inches in length.

9. The compression tool of claim 7, wherein the fixed element is welded to the first member.

10. The compression tool of claim 7, wherein the distance between the first bottom portion and the second bottom portion is adjustable up to 2 inches inward toward each other.

11. The compression tool of claim 7, wherein the compression tool can overcome a separation force of approximately between 200 and 300 pounds.

12. The compression tool of claim 7, wherein the first member is larger in height and width than the second member.

13. The compression tool of claim 7, wherein the adjustable element further comprises an adjusting mechanism.

14. The compression tool of claim 13, wherein the adjusting mechanism comprises a nut and a washer.

15. A compression tool for use with a breakaway coupling suitable for use with anhydrous ammonia, the compression tool comprising:
a first member comprising a first top portion and a first bottom portion, wherein the first bottom portion comprises an approximately U-shaped cut-out portion; and
a second member comprising a second top portion and a second bottom portion, wherein the second bottom portion comprises an approximately U-shaped cut-out portion; and
a fixed element, wherein the fixed element secures the first member to the second member between the first top portion and the second top portion; and
an adjustable element for adjusting a distance between the first bottom portion and the second bottom portion, wherein the adjustable element allows the first member to move relative to the second member.

16. The compression tool of claim 15, wherein the approximately U-shaped cut-out portion of the first member is larger that the approximately U-shaped cut-out portion of the second member.

17. The compression tool of claim 16, wherein the approximately U-shaped cut-out portion of the first member is approximately 2¾ inches in width and 3¾ inches in height, and the approximately U-shaped cut-out portion of the second member is approximately 1⅝ inches in width and 1¾ inched in height.

18. The compression tool of claim 14, wherein the first member is approximately 5 inches in width, 7½ inches in height, and ½ inches in thickness.

19. The compression tool of claim 18, wherein the second member is approximately 4½ inches in width, 6¼ inches in height, and ½ inches in thickness.

20. The compression tool of claim 14, wherein the compression tool is used with a Flo-Max® Coupler.
